(19) United States
(12) Patent Application Publication
(10) Pub. No.: US 2026/0212369 A1
(43) Pub. Date: Jul. 23, 2026

(54) ENTERPRISE PAYMENT GATEWAY

(71) Applicant: Wells Fargo Bank, N.A., San Francisco, CA (US)

(72) Inventors: Ramanand Bulusu, Hyderabad (IN); Jiten Sharma, Bareilly (IN); Manas Pattanaik, Charlotte, NC (US); Vijaykumar Akula, Hyderabad (IN)

(21) Appl. No.: 19/026,872

(22) Filed: Jan. 17, 2025

(51) Int. Cl. G06Q 20/42

(52) U.S. Cl. CPC G06Q 20/425

(57) ABSTRACT

Techniques are described for connecting payment execution systems with external payment networks to exchange payment and non-payment messages. The disclosed enterprise payment gateway system is configured to distribute two or more messages of a plurality of messages destined for one or more external payment network across two or more delivery channels; process, via a first thread of execution of multi-threaded processing circuitry, a first message of the two or more messages in a first delivery channel for transmission to the external payment network; process, via a second thread of execution of the multi-threaded processing circuitry in parallel with the first thread, a second message of the two or more messages in a second delivery channel for transmission to the external payment network; and send the first message to a first messaging queue and the second message to a second messaging queue for transmission to the external payment network.

### TECHNICAL FIELD

The disclosure relates to computing systems and, in particular, computing systems that manage messaging with payment networks.

### BACKGROUND

Financial institutions, including banks and credit unions, rely on networks to process payments securely. These networks operate under predefined rules that control payment network traffic, ensuring the secure management of various payment methods. To interact with a payment network, payment message management systems must adhere to specific rules and protocols for the payment network. Adhering to these rules is crucial for maintaining the security and efficiency of financial transactions. For example, a payment network may require receipt of messages having unique sequence numbers in an ascending sequence, where each sequence number is incremented by one for each subsequent message. To adhere to this rule, payment message management systems may be constrained to only send one message at a time to ensure the messages are sent to and received by the payment network in sequence. This sequential numbering system helps maintain the integrity of transactions and ensures that the messages are processed in a correct order.

### SUMMARY

In general, this disclosure describes techniques for connecting payment execution systems with external payment networks to exchange payment messages and non-payment messages. The disclosed techniques comprise one or more enterprise payment gateways (EPGs) running on one or more computing systems operating within one or more data centers of an organization to provide high-availability, resiliency, and scalability to payment message management while adhering to payment network rules of the external payment networks. An EPG may operate as an isolation layer that provides flexibility to direct wire transfer volume between external payment networks while reducing risk, data issues, vendor dependence, and technical re-work during payment execution engine migration.

In accordance with the disclosed techniques, an EPG obtains messages from one or more enterprise payment execution systems and distributes the messages destined for an external payment network for parallel or simultaneous processing for transmission to the external payment network, e.g., one of FedWire (Federal Reserve Wire Network), CHIPS (Clearing House Interbank Payments System), or SWIFT (Society of Worldwide Interbank Financial Telecommunications). For example, the EPG may distribute the messages across all available delivery channels for the external payment network, where each delivery channel processes a message for transmission to the external payment network in accordance with the payment network rules for the external payment network. For example, one payment network rule may require that each message is assigned a unique sequence number and that each message must be received in ascending sequential order with the sequence numbers incremented by one for each successive message.

The EPG performs multi-threaded operations to enable parallel or simultaneous processing of two or more messages across two or more delivery channels for transmission to the external payment network. Within each of the delivery channels, the EPG performs single-threaded operations on each message to validate the delivery channel and generate a sequence number for the message from a set of sequence numbers that are unique to the delivery channel, such that each delivery channel outputs messages in ascending sequential order in accordance with the payment network rules. The EPG then again performs multi-threaded operations to send the messages from the delivery channels to respective messaging queues for transmission to the external payment network. The EPG may automatically route messages to other available delivery channels for the external payment network in response to processing errors or issues and/or transmission errors or issues to minimize processing delays. The EPG may include a channel manager configured to monitor and, when needed, reset the set of sequence numbers for each delivery channel.

The EPG may manage an isolated or discrete set of delivery channels for each external payment network to enable parallel or simultaneous processing and transmission of messages for each external payment network. In some examples, each EPG of two or more EPGs operates in an active mode within each data center of two or more data centers. In this way, not only does each EPG parallel process and transmit messages for each external payment network, but multiple EPGs may operate in parallel across multiple data centers. Compared to conventional payment message management systems that are constrained to only send one message at a time, the EPG provides automated and reengineered workflows that enable payment network interaction based on payment network rules with high-availability, improved performance, and superior resiliency. The EPG may further provide improved payment network line management and enable standardized implementation of business or regulatory changes with respect to payment networks and/or payment message management.

In one example, this disclosure is directed to a computing system comprising a memory and processing circuitry in communication with the memory. The processing circuitry and configured to distribute two or more messages of a plurality of messages destined for an external payment network across two or more delivery channels; process, via a first thread of execution, a first message of the two or more messages in a first delivery channel of the two or more delivery channels for transmission to the external payment network; process, via a second thread of execution in parallel with the first thread, a second message of the two or more messages in a second delivery channel of the two or more delivery channels for transmission to the external payment network; and based on successful processing of the first message and the second message, send the first message to a first messaging queue and the second message to a second messaging queue for transmission to the external payment network.

In another example, this disclosure is directed to a method comprising distributing, by a computing system, two or more messages of a plurality of messages destined for an external payment network across two or more delivery channels; processing, via a first thread of execution of processing circuitry of the computing system, a first message of the two or more messages in a first delivery channel of the two or more delivery channels for transmission to the external payment network; processing, via a second thread of execution of the processing circuitry of the computing system in parallel with the first thread, a second message of the two or more messages in a second delivery channel of the two or more delivery channels for transmission to the external payment network; and based on successful processing of the first message and the second message, sending, by the computing system, the first message to a first messaging queue and the second message to a second messaging queue for transmission to the external payment network.

In a further example, this disclosure is directed to non-transitory computer-readable media storing instructions that, when executed, cause processing circuitry to distribute two or more messages of a plurality of messages destined for an external payment network across two or more delivery channels; process, via a first thread of execution, a first message of the two or more messages in a first delivery channel of the two or more delivery channels for transmission to the external payment network; process, via a second thread of execution in parallel with the first thread, a second message of the two or more messages in a second delivery channel of the two or more delivery channels for transmission to the external payment network; and based on successful processing of the first message and the second message, send the first message to a first messaging queue and the second message to a second messaging queue for transmission to the external payment network.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example network system including enterprise payment gateways (EPGs) running on a computing system across a plurality of data centers of an organization that are in communication with external payment networks, in accordance with one or more techniques of this present disclosure.

FIG. 2 is a conceptual diagram illustrating an example flow of outbound and inbound messages between an EPG connector service, messaging queues, and an external payment network, in accordance with one or more aspects of the present disclosure.

FIG. 3 is a block diagram illustrating an example computing system including an EPG configured to distribute and process messages for transmission to external payment networks, in accordance with one or more techniques of the present disclosure.

FIG. 4 is a conceptual diagram illustrating an example flow of outbound messages within an EPG connector service, in accordance with one or more techniques of the present disclosure.

FIG. 5 is a flowchart illustrating an example operation of providing an enterprise payment gateway to distribute and process messages for transmission to an external payment network, in accordance with one or more techniques of this disclosure.

Like reference characters denotes like elements throughout the text and figures.

### DETAILED DESCRIPTION

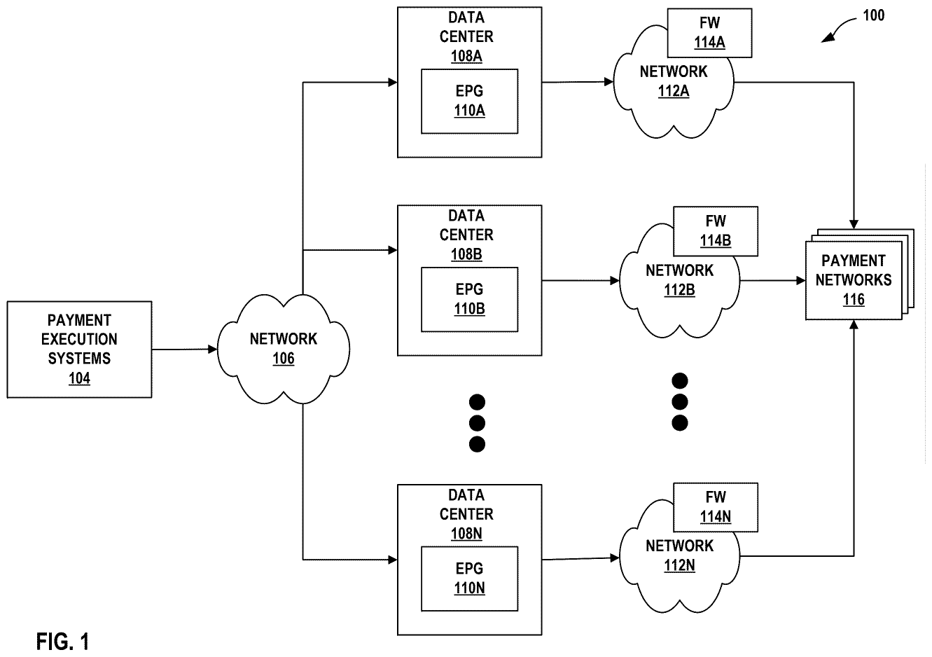

FIG. 1 is a block diagram illustrating an example network system 100 including enterprise payment gateways (EPGs) 110A-110N (collectively, “EPGs 110”) running on a computing system across a plurality of data centers 108A-108N of an organization that are in communication with one or more external payment networks 116, in accordance with one or more techniques of this present disclosure. In FIG. 1, network system 100 is illustrated as including payment execution systems 104 communicating over private network 106 to the plurality of data centers 108A-108N (collectively “data centers 108”). Each of data centers 108 is illustrated as hosting one of EPGs 110, which communicate over networks 112A-112N (collectively “networks 112”) via firewalls 114A-114N (collectively “firewalls 114”), respectively, to send payment and non-payment messages to external payment networks 116.

Payment execution systems 104 may include one or more different types of payment execution systems associated with the organization that are traditionally configured to manage and process payments, by the organization itself or on behalf of the organization's customers, with external payment networks 116. External payment networks 116 may include one or more fund transfer or settlement systems, e.g., one or more of FedWire (Federal Reserve Wire Network), CHIPS (Clearing House Interbank Payments System), or SWIFT (Society of Worldwide Interbank Financial Telecommunications). For example, FedWire is a real-time gross settlement funds transfer system operated by the Federal Reserve Banks in the United States that allows participating financial institutions to electronically transfer funds between each other on a transaction-by-transaction basis. CHIPS is a private sector gross settlement funds transfer system. CHIPS may be slower but less expensive than FedWire, making it useful for high-value transactions that do not need real-time or same day settlement. SWIFT is a messaging system that instructs financial institutions to move funds between accounts but does not actually move the funds. SWIFT is a non-profit cooperative that is used to identify banks and financial institutions globally for international transactions.

Network system 100 illustrated in FIG. 1 includes private network 106 and one or more networks 112, each of which may be private or public networks. Devices connected to private network 106, e.g., payment execution systems 104 and data centers 108, may be part of a secure network not normally accessible to the public, such as an enterprise network, organizational network, or virtual private network. Although private network 106 is illustrated as a single network and may be principally located within one location, private network 106 may also comprise multiple networks and be geographically distributed across multiple locations.

For example, for a large organization, computing and storage resources may be provided through multiple data centers 108 deployed within or accessible via private network 106. Computing devices within each of data centers 108 may host enterprise applications and/or services, e.g., EPGs 110, and provide a platform for execution of applications and/or services provided to customers, employees, or other applications of the organization through private network 106. In some examples, each of data centers 108 may be located in a geographically disparate location in order to provide high-speed services to customers, employees, or other applications of the organization in the same geographic location and/or to provide redundancy and resiliency for the applications and services hosted or executed by data centers 108. In the illustrated example of FIG. 1, payment execution systems 104 may comprise one or more applications running on local computing devices at a particular geographic location of the organization that is connected to data centers 108 via private network 106. In other examples, payment execution systems 104 may comprise one or more applications running on one or more of data centers 108.

Networks 112 may comprise public networks, private networks, or a combination thereof. In some examples, each of networks 112 may comprise access or intermediate networks through which a corresponding one of data centers 108 may connect to the Internet and/or to one of payment networks 116. Although networks 112 are illustrated in FIG. 1 as distinct networks for each of data centers 108, networks 112 may alternatively comprise a single public network, e.g., the Internet.

As shown in FIG. 1, devices connected to private network 106, e.g., payment execution systems 104 and data centers 108, are separated from payment networks 116 and/or other external networks via firewalls (FW) 114. Firewalls 114 may be in place to ensure that users or services of external networks do not have access to sensitive customer account and financial data stored and managed by the organization at data centers 108. In at least one example, each of firewalls 114 is a network security device that allows or blocks traffic to a corresponding one of data centers 108 based on a defined set of security rules.

In accordance with the disclosed techniques, EPGs 110 hosted on data centers 108 connect payment execution systems 104 with external payment networks 116 to exchange payment messages and non-payment messages. Each of EPGs 110 may operate as an isolation layer between payment execution systems 104 and external payment networks 116 that provides flexibility to direct wire transfer volume to external payment networks 116 while reducing risk, data issues, vendor dependence, and technical re-work during payment execution engine migration.

Compared to conventional payment message management systems that are constrained to only send one message at a time to adhere to payment network rules, each of EPGs 110 provide automated and reengineered workflows that enable interaction with external payment networks 116 based on payment network rules with high-availability, improved performance, and superior resiliency. Each of EPGs 110 may further provide improved payment network line management and enable standardized implementation of business or regulatory changes with respect to external payment networks 116 and/or payment message management.

EPGs 110 provide high-availability, resiliency, and scalability to payment message management while adhering to payment network rules of the external payment networks. More specifically, each of EPGs 110 includes a connector service dedicated for each of the one or more external payment networks 116. For example, a first connector service of one of EPGs 110, e.g., EPG 110A, may be dedicated to the FedWire network, a second connecter service of EPG 110A may be dedicated to the CHIPS network, and a third connecter service of EPG 110A may be dedicated to the SWIFT network. A connector service within EPG 110A for one of payment networks 116 includes an isolated or discrete set of two or more delivery channels, each configured to process and transmit messages destined for the one of payment networks 116. In this way, each of EPGs 110 provides parallel or simultaneous processing and transmission of messages for each of external payment networks 116. In addition, in some examples, two or more of EPGs 110 operate in highly available or active mode within their respective data centers 108. For example, in a scenario where an organization includes three data centers 108, EPGs 110 may operate in active-active-active mode across the three data centers 108. In this way, not only does each of EPGs 110 parallel process and transmit messages for each external payment network, but multiple EPGs 110 may operate in parallel across multiple data centers 108.

According to the disclosed techniques, at least one of EPGs 110, e.g., EPG 110A, obtains messages from payment execution systems 104 and distributes the messages destined for one of payment networks 116 across the two or more delivery channels of the dedicated connector service for the one of payment networks 116. The messages may be payment message or non-payment messages destined for particular ones of external payment networks 116. For example, EPG 110A may distribute the messages across all available delivery channels for the one of payment networks 116, where each delivery channel processes one of the messages in accordance with the payment network rules for the one of payment networks 116. For example, one payment network rule may require that each message is assigned a unique sequence number and that each message must be received in ascending sequential order with the sequence numbers incremented by one for each successive message.

EPG 110A performs multi-threaded operations to enable parallel or simultaneous processing of two or more messages across the two or more delivery channels for the one of payment networks 116. Within each of the delivery channels, EPG 110A performs single-threaded operations on each message to validate the delivery channel and generate a sequence number for the message from a set of sequence numbers that are unique to the delivery channel, such that each delivery channel outputs messages in ascending sequential order in accordance with the payment network rules. EPG 110A then again performs multi-threaded operations to send the two or more messages from the two or more delivery channels to respective messaging queues for transmission to the one of payment networks 116 via network 112A and FW 114A.

Each of EPGs 110 may also perform advance monitoring and self-healing techniques to avoid and/or minimize processing delays due to messages being stuck in a failed delivery channel. For example, EPG 110A may automatically route messages from a first delivery channel to other available delivery channels of the dedicated connector service for the one of payment networks 116 in response to processing errors or issues and/or transmission errors or issues associated with the first delivery channel. EPG 110A may also reconfigure, shut down, or restart a channel distributor to avoid distributing additional messages to a failed delivery channel. In addition, EPG 110A may include a channel manager configured to monitor and, when needed, reset the set of sequence numbers for each delivery channel.

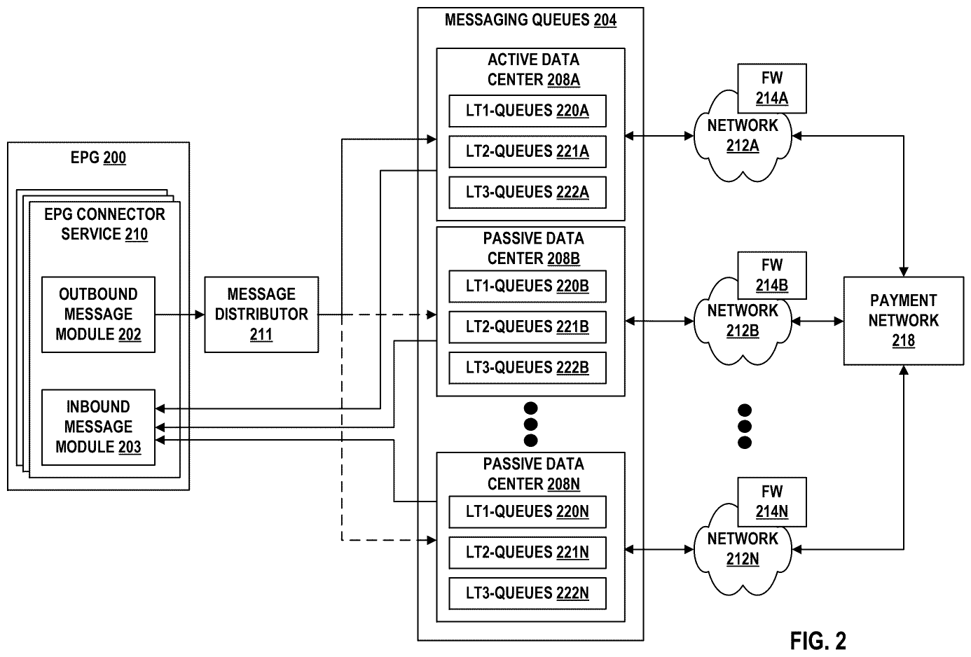

FIG. 2 is a conceptual diagram illustrating an example flow of outbound and inbound messages between an EPG 200, messaging queues 204, and an external payment network 218, in accordance with one or more aspects of the present disclosure. In some examples, EPG 200 may operate substantially similar to any of EPGs 110 of FIG. 1. Similarly, payment network 218 may be one of payment networks 116 of FIG. 1.

In the illustrated example of FIG. 2, EPG 200 includes an EPG connector service 210 that includes an outbound message module 202 and an inbound message module 203. EPG connector service 210 may be a dedicated connector service for external payment network 218. For example, EPG connector service 210 may comprise an isolated or discrete set of two or more delivery channels, each configured to process and transmit messages destinated for payment network 218. In some examples, EPG 200 may include additional connector services that are dedicated for other external payment networks.

EPG connector service 210 connects to payment network 218 via messaging queues 204 within each data center 208A-208N (collectively “data centers 208”), which communicate over networks 212A-212N (collectively “networks 212”) via firewalls 214A-214N (collectively “firewalls 214”), respectively, to send payment and non-payment messages to external payment network 218. Data centers 208 may operate substantially similar to data centers 108 from FIG. 1. For example, although illustrated in FIG. 2 as though EPG 200 is running outside of data centers 208, an instance of EPG 200 may be running on one or more of data centers 208. In addition, networks 212 and firewalls 214 may operate substantially similar to networks 112 and firewalls 114 from FIG. 1.

Data centers 208 is illustrated as hosting a set of logical terminal (LT) queues, e.g., LT1-queues 220A-220N, LT2-queues 221A-221N, and LT3-queues 222A-222N. For example, data center 208A (the “active” data center in this example) hosts active LT1-queues 220A, active LT2-queues 221A, and active LT2-queues 222A. Data center 208B (a “passive” data center in this example) hosts passive LT1-queues 220B, passive LT2-queues 221B, and passive LT2-queues 222B. Similarly, data center 208N (a “passive” data center in this example) hosts passive LT1-queues 220N, passive LT2-queues 221N, and passive LT2-queues 222N.

EPG connector service 210 is configured to process and send payment messages and non-payment messages to payment network 218 as defined by the payment network rules of payment network 218. More specifically, outbound message module 202 of EPG connector service 210 ensures that outbound messages will not be rejected by payment network 218 for failure to adhere to the payment network rules and/or due to issues with the delivery channel. The payment network rules may define a format of messages, an order of messages, priority of messages, and/or timing of message receipt and message settlement. For example, one payment network rule may require that each message is assigned a unique sequence number and that each message must be received in ascending sequential order with the sequence numbers incremented by one for each successive message.

According to the disclosed techniques, outbound message module 202 parallel processes two or more messages destined for payment network 218 while adhering to the payment network rules of payment network 218. For example, outbound message module 202 distributes the two or more messages across two or more delivery channels within EPG connector service 210 dedicated for payment network 218. Within each delivery channel, outbound message module 202 generates and assigns a sequence number for each message from a set of sequence numbers unique to the delivery channel. Within each delivery channel, outbound message module 202 may also perform one or more operations to determine whether the message adheres to the rules of payment network 218, e.g., whether the delivery channel is operating properly and/or whether the message is a duplicate message. Based on successful processing of the two or more messages by the two or more delivery channels, outbound message module 202 may send, simultaneously or substantially simultaneously, the two or more messages to message distributor 211 for distribution to messaging queues 204.

As illustrated in FIG. 2, message distributor 211 may only distribute the outbound messages the active LT queues 220A, 221A, 222A within active data center 208A (e.g., shown as a solid-line arrow to active data center 208A as opposed to dashed-line arrows to passive data centers 208B, 208C). The active LT queues 220A, 221A, 222A then transmit the messages to payment network 218 via network 212A and firewall 214A. In the event that the active data center, e.g., data center 208A, experiences a failure, messaging queues 204 will automatically assign one of the passive data centers, e.g., data center 208B, as the new primary or active data center. Subsequently, the message distributor 211 will continue to distribute the two or more messages, along with their associated sequence numbers, to the appropriate LT queues 220B, 221B, 222B within the newly designated active data center 208B. This setup ensures high availability and fault tolerance, as the system can seamlessly transition between data centers without disrupting the message flow to the payment network 218.

Upon receipt of at least one of the messages, payment network 218 may send an acknowledgment message to EPG connector service 210 dedicated for payment network 218 via messaging queues 204. As illustrated in FIG. 2, inbound message module 203 of EPG connector service 210 reads or receives messages from all of data centers 208. Based on receipt of an acknowledgement message in response to transmission of a first message from a first delivery channel of EPG connector service 210 to payment network 218, inbound message module 203 may prompt outbound message module 202 to process and send a successive message distributed to the first delivery channel.

Based on not receiving an acknowledgement message in response to transmission of the first message from a first delivery channel of EPG connector service 210 to payment network 218 within a time out period, inbound message module 203 may prompt outbound message module 202 to shut down the first delivery channel and reroute successive messages distributed to the first delivery channel to another one of the two or more delivery channels for processing.

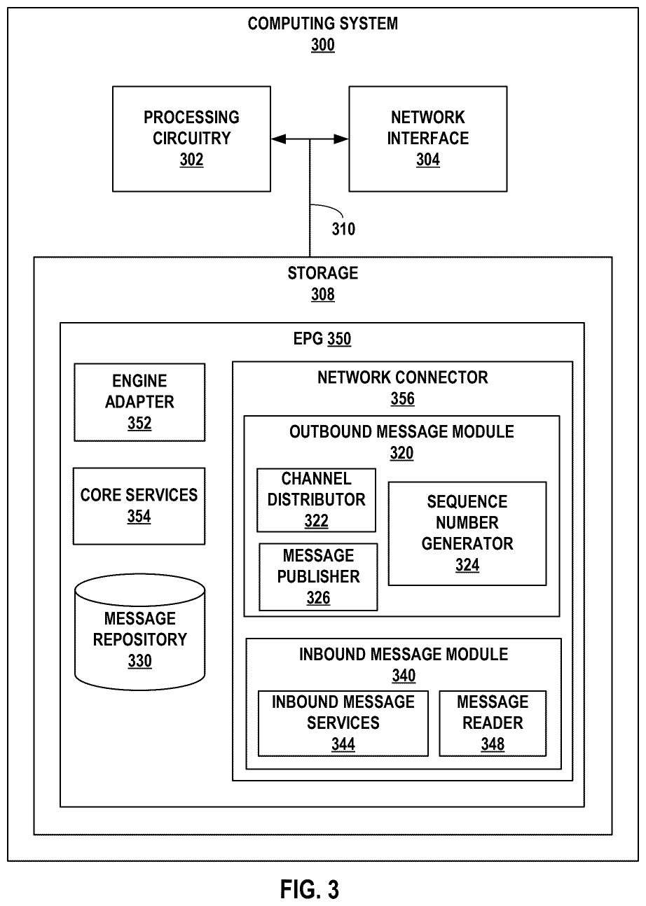

FIG. 3 is a block diagram illustrating an example computing system 300 including an EPG 350 configured to distribute and process messages for transmission to external payment networks, in accordance with one or more techniques of the present disclosure. Computing system 300 of FIG. 3 is illustrated as a block diagram with specific components and data modules. In some examples, computing system 300 may correspond to a computing device within one of data centers 108 configured to host or execute one of EPGs 110 of FIG. 1. For ease of illustration, computing system 300 is illustrated in FIG. 3 as a single computing system. However, in other examples, computing system 300 may comprise multiple devices or systems, such as a distributed computing system that operates across a data center or multiple data centers. Alternatively, or in addition, computing system 300 (or various modules illustrated in FIG. 3 as included within computing system 300) may be implemented through distributed virtualized compute instances (e.g., virtual machines, containers) of a data center, cloud computing system, server farm, and/or server cluster.

In FIG. 3, computing system 300 is illustrated as including processing circuitry 302, network interface 304, and storage 308. In accordance with the disclosed techniques, storage 308 includes EPG 350 having an engine adapter 352, core services 354, a network connector 356, and a message repository 330. One or more of the devices, modules, storage areas, or other components of computing system 300 may be interconnected to enable inter-component communications (physically, communicatively, and/or operatively). In some examples, such connectivity may be provided by through communication channels 310, which may include a system bus, a network connection, an inter-process communication data structure, or any other method for communicating data.

Processing circuitry 302 may include one or more processors such as a virtualized processor, multi-core processor, or other type of processor. Processing circuitry 302 may provide an execution environment for computing system 300 and may implement functionality and/or execute instructions stored in storage 308. Processing circuitry 302 may be, may be part of, and/or may include processing circuitry that performs operations in accordance with one or more aspects of the present disclosure. For example, processing circuitry 302 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry. In particular, in accordance with the disclosed techniques, processing circuitry 302 includes one or more multi-threaded processors capable of running multiple threads in parallel or simultaneously using different cores.

Network interface 304 of computing system 300 may facilitate the exchange of data and communication with other devices or systems via one or more networks by transmitting and/or receiving network signals on the one or more networks. Examples of network interfaces 304 include a network interface card (e.g., such as an Ethernet card), an optical transceiver, a radio frequency transceiver, or any other type of device that can send and/or receive information, such as through a wired or wireless network. Other examples of interfaces 304 may include short wave radios, cellular data radios, wireless Ethernet network radios, as well as universal serial bus (USB) controllers.

In some examples, interfaces 304 of computing system 300 may operate as input and/or output devices. Examples of input are tactile, audio, and video input. Examples of interfaces 304 configured to receive input include a presence-sensitive screen, touch-sensitive screen, mouse, keyboard, voice responsive system, video camera, microphone, or any other type of device for detecting input from a human or machine. Examples of output are tactile, audio, and video output. Examples of interfaces 304 configured to generate output include a presence-sensitive screen, sound card, video graphics adapter card, speaker, cathode ray tube (CRT) monitor, liquid crystal display (LCD), or any other type of device for generating output to a human or machine.

Storage 308, in some examples, also include one or more computer-readable storage media. Storage 308 may be configured to store larger amounts of information than volatile memory. Storage 308 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories.

Storage 308 may store program instructions and/or data associated with one or more of the modules described in accordance with one or more aspects of this disclosure. In the illustrated example of FIG. 3, storage 308 may store instructions and/or data associated with EPG 350. Processing circuitry 302 and storage 308 may provide an operating environment or platform for such modules, which may be implemented as software, but may in some examples include any combination of hardware, firmware, and software. Processing circuitry 302 may execute instructions and storage 308 may store instructions and/or data of one or more modules. The combination of processing circuitry 302 and storage 308 may retrieve, store, and/or execute the instructions and/or data of one or more applications, modules, or software. Processing circuitry 302 and/or storage 308 may also be operably coupled to one or more other software and/or hardware components, including, but not limited to, one or more of the components of computing system 300 and/or one or more devices or systems illustrated or described as being connected to computing system 300.

In the illustrated example of FIG. 3, EPG 350 includes engine adapter 352, core services 354, network connector 356, and message repository 330. Engine adapter 352 enables EPG 350 to interact with a wide range of payment execution systems, e.g., payment execution systems 104 from FIG. 1. Engine adapter 352 within EPG 350 may serve as an intermediary or connector that facilitates communication, translation, validation, and confirmation between one or more payment execution systems and network connector 356. For example, different payment execution systems may use different communication protocols, data formats, or application programming interfaces (APIs). Engine adapter 352 may translate or convert payment messages and non-payment messages obtained from one or more payment execution systems into a standard format.

Core services 354 enable network connector 356 of EPG 350 to process payment and non-payment message for transmission to the particular payment network. For example, core services 354 may provide a workflow orchestrator, rule engines, monitor services, reporting services, liquidity services, common libraries, and/or a user interface API. In cases where core services 354 provide a workflow orchestrator, core services 354 may filter and/or route the payment messages and non-payment messages obtained via engine adapter 352 to the appropriate network connector, e.g., network connector 356, dedicated to the external payment network to which the messages are destined. In some examples, during the workflow orchestration process, core services 354 may temporarily store or cache messages in message repository 330.

In cases where core services 354 provide a user interface (UI) API, core services 354 may receive user input from administers of EPG 356 to initiate reconfiguration, reset, shut down, or restart of one or more components of network connector 356. As one example, core services 354 may receive user input to initiate a reset of a particular set of sequence numbers for a particular delivery channel within network connector 356. As another example, core services 354 may receive user input to initiate a replay or retry of transmission for a particular message. As a further examples, core services 354 may receive user input to initiate a shutdown or restart of a particular delivery channel within network connector 356.

Network connector 356 may be a dedicated connector service for a particular external payment network, e.g., FedWire. For example, network connector 356 may comprise an isolated or discrete set of two or more delivery channels, each configured to process and transmit messages destinated for the particular payment network. In some examples, EPG 350 may include additional connector services that are dedicated for other external payment networks, e.g., CHIPS or SWIFT. In some examples, network connector 356 of EPG 350 may operate similar to EPG connector service 210 of EPG 200 from FIG. 2.

Network connector 356 includes an outbound message module 320 and an inbound message module 340. Outbound message module 320 includes a channel distributor 322, a sequence number generator 324, and a message publisher 326. Channel distributor 322 distributes two or more messages of a plurality of messages destined for the particular payment network across the two or more delivery channels for the particular payment network. Channel distributor 322 may load balance the message across the delivery channels, e.g., using a round robin algorithm. In response to processing errors or issues and/or transmission errors or issues associated with one of the delivery channels, channel distributor 322 may automatically route messages from a first delivery channel to other available delivery channels of network connector 356 for the particular payment network. In addition, if one of the delivery channels fails for any reason, outbound message module 320 may reconfigure, shut down, or restart channel distributor 322 to avoid distributing additional messages to the failed delivery channel. The message distribution techniques may be performed using multi-threaded processing of processing circuitry 302 to enable parallel or simultaneous processing of the two or more messages across the two or more delivery channels for the particular payment network.

Within each delivery channel of network connector 356, sequence number generator 324 generates a sequence number for each message distributed to the delivery channel from a set of sequence numbers unique to the delivery channel. Sequence number generator 324 then increments the set of sequence numbers unique to the delivery channel in preparation for a successive message distributed to the same delivery channel, e.g., in order to adhere to a payment network rule that each message is assigned a unique sequence number and that each message must be received in ascending sequential order with the sequence numbers incremented by one for each successive message.

Based on an error or exception associated with the message for which a sequence number was last generated, sequence number generator 324 may decrement the set of sequence numbers unique to the delivery channel back to a prior sequence number. In this way, sequence number generator 324 is able to properly manage the set of sequence numbers unique to the delivery channel and avoid having messages rejected by the particular payment network for failure to adhere to the payment network rules.

Within each delivery channel, outbound message module 320 also performs one or more operations to determine whether the message will be rejected by the particular payment network, e.g., whether the delivery channel is ready to process the message, whether the message is a duplicate message and/or whether the message adheres to the rules of the particular payment network. If the message passes the checks, the message is passed to message publisher 326. The message processing techniques within each delivery channel, e.g., validation, duplicate check, and sequence number generation, may be performed using single-threaded processing of processing circuitry 302 to perform the serial operations in order.

Based on successful processing of the two or more messages by the two or more delivery channels of network connector 356, message publisher 326 may send the two or more messages to two or more messaging queues for transmission to the particular payment network. Again, the message distribution techniques may be performed using multi-threaded processing of processing circuitry 302 to enable parallel or simultaneous distribution of the two or more processed messages and their sequence numbers for transmission to the particular payment network. In some examples, core services 354 may store the transmitted or delivered messages in message repository 330, which may be accessed to perform a delivery audit based on incoming acknowledgement messages.

Inbound message module 340 includes inbound message services 344 and message reader 348. Message reader 348 receives messages from the particular payment network for network connector 356. The inbound message may include acknowledgement messages sent by the particular payment network in response to successful receipt of message processed by outbound message module 320. In other examples, the inbound messages may include administrative messages.

Message reader 348 may parse the messages to extract identifying information, e.g., the unique sequence number assigned to the message being acknowledged, an identifier of the source payment execution system, or an identifier for an administrative message associated with the particular payment network and/or the source payment execution system. Message reader 348 may then route the messages to the appropriate inbound message services 344, e.g., acknowledgement message service or an admin message service. In some examples, core services 354 may store the acknowledgement and/or administrative messages in message repository 330.

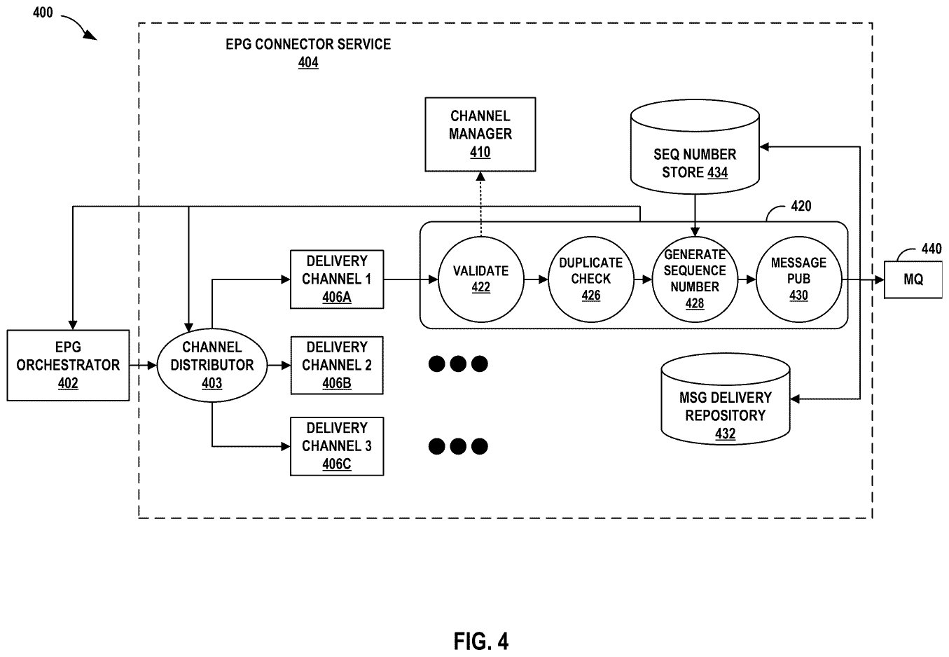

FIG. 4 is a conceptual diagram illustrating an example flow of outbound messages within an EPG connector service 404 of an EPG 400, in accordance with one or more techniques of the present disclosure. EPG 400 may operate substantially similar to any of EGPs 110 of FIG. 1, EGP 200 of FIG. 2, or EPG 350 of FIG. 3. EPG connector service 404 may operate substantially similar EPG connector service 210 of EPG 200 from FIG. 2 and/or network connector 356 of EPG 350 from FIG. 3.

In the illustrated example of FIG. 4, EPG connector service 404 comprises an isolated or discrete set of three delivery channels 406A-406C (collectively “delivery channels 406”), each configured to parallel process and transmit messages destinated for a particular payment network (not shown in FIG. 4) via a messaging queue (MQ) 440. EPG connector service 404 also includes a channel distributor 403, sequence number manager 410, message delivery repository 432, and a sequence number store 434. Each of delivery channels 406 is configured to perform a series of operations 420 on a message distributed to delivery channel. Operations 420 may include validate 422, duplicate check 426, generate sequence number 428, and message publisher 430. Although operations 420 are only illustrated for delivery channel 1 406A, each of delivery channel 2 406B and delivery channel 3 406C would also perform operations 420.

EPG orchestrator 402 may filter and/or route payment messages and non-payment messages obtained from different payment execution systems to the appropriate network connector of EPG 400. For example, EPG orchestrator 402 may route payment messages and non-payment messages destined for the particular payment network to EPG connector service 404 dedicated for the particular payment network.

Channel distributor 403 distributes messages of a plurality of messages destined for the particular payment network across the available delivery channels 406 for the particular payment network. Channel distributor 403 may load balance the message across delivery channels 406, e.g., using a round robin algorithm. In response to an error or issue associated with one of delivery channels 406, channel distributor 403 may automatically route messages from, e.g., delivery channel 1 406A to another available delivery channel, e.g., delivery channel 2 406B. In addition, if one of delivery channels 406, e.g., delivery channel 3 406C, fails for any reason, that channel may be designated as “unavailable.” Channel distributor 403 may, automatically or after a reconfiguration or restart, continue to distribute messages across the remaining available channels, e.g., delivery channel 1 406A and delivery channel 2 406B, to avoid distributing additional messages to the failed delivery channel.

Channel distributor 403 may comprise a Representational State Transfer (REST) API. Channel distributor 403 may be performed using multi-threaded processing to enable parallel or simultaneous processing of messages by delivery channels 406. For example, channel distributor 403 distributes, via a first thread of execution, a first message to delivery channel 1 406A, distributes, via a second thread of execution, a second message to delivery channel 2 406B, and distributes, via a third thread of execution, a third message to delivery channel 3 406C. Upon receipt of the distributed messages, delivery channels 406 may process the three messages in parallel for transmission to the particular payment network via MQ 440.

Within each of delivery channels 406, operations 420 are performed on the particular message distributed to the respective delivery channel. The series of operations 420 may be performed using single-threaded processing within each of delivery channels 406. In some examples delivery channels 406 may be built on a data streaming platform, e.g., Kafka, in which the messages are distributed to delivery channels 406 and consumed by operations 420 of the respective delivery channel.

For example, delivery channel 1 406A performs operations 420 to determine whether the first message adheres to one or more rules of the particular payment network to which the first message is destined. Delivery channel 1 406A performs validate operation 422 to validate whether first delivery channel 1 406A and an associated queue of MQ 440 is ready to process the first message. In some examples, validate operation 422 may validate the channel and the associated queue based on information maintained in channel manager 410. Once the delivery channel is validated, delivery channel 1 406A performs duplicate check operation 426 to determine whether the first message in delivery channel 1 406A is a duplicate message of another message in another one of the two or more delivery channels 406B, 406C. If the channel is valid and the message is not a duplicate message, delivery channel 1 406A performs generate sequence number operation 428 to generate a first sequence number for the first message from a set of sequence numbers unique to delivery channel 1 406A, e.g., stored in sequence number store 434, in a manner that adheres to one or more rules of the particular payment network. After the first sequence number is generated and assigned to the first message, delivery channel 1 406A performs message publisher operation 430 to prepare to send the first message to an associated queue of MQ 440.

Once the first message has reached message publisher operation 430, operations 420 enable sequence number store 434 to increment the set of sequence numbers unique to delivery channel 1 406A in preparation for a successive message distributed to delivery channel 1 406A. In the illustrated example, sequence number store 434 increments the next available sequence number to be one more than the first sequence number generated for the first message. In this way, delivery channel 1 406A may adhere to a payment network rule that each message is assigned a unique sequence number and that each message must be received in ascending sequential order with the sequence numbers incremented by one for each successive message.

If any of operations 420 fail when processing the first message, operations 420 and/or delivery channel 1 406A may report an error or exception back to EPG orchestrator 402 and/or channel distributor 403. If, at the time of the error or exception, the first sequence number had already been generated for the first message, sequence number store 434 decrements the next available sequence number back to the first sequence number. In this way, sequence number store 434 maintains the order of sequence numbers assigned to messages processed within delivery channel 1 406A and avoids having messages rejected by the particular payment network for failure to adhere to the payment network rules.

Based on successful processing of the first message by operations 420, message publisher operation 430 performed by delivery channel 1 406A may send the first message to a first queue of MQ 440 for transmission to the particular payment network. Delivery channel 2 406B and delivery channel 3 406C, which processed the second message and third message, respectively, in parallel with the first message in delivery channel 1 406A, may also send the second message and third message to a second queue and third queue of MQ 440. Message publisher operations 430 across all active delivery channels 406 may be performed using multi-threaded processing to enable parallel or simultaneous transmission of messages by delivery channels 406 to associated queues of MQ 440. For example, delivery channel 1 406A sends, via a first thread of execution, the first message and its assigned first sequence number to the first queue of MQ 440, delivery channel 2 406B sends, via a second thread of execution, the second message and its assigned second sequence number to the second queue of MQ 440, and delivery channel 3 406C sends, via a third thread of execution, the third message and its assigned third sequence number to the third queue of MQ 440. Each of delivery channels 406 may store the transmitted messages in message delivery repository 432 to await performance of a delivery audit based on incoming acknowledgement messages from the particular payment network.

Message delivery repository 432 stores, logs, and tracks the status of outgoing messages (e.g., payment messages and non-payment messages) as they are processed through EPG connector service 404. Message delivery repository 432 may store a complete history of all outgoing messages, including timestamps, status updates, and processing outcomes. This allows for detailed auditing and tracing of transactions, which is crucial for regulatory compliance and troubleshooting. For example, based on receipt of an acknowledgement message in response to successful delivery of the first message processed by delivery channel 1 406A to the particular payment network, message delivery repository 432 may instruct delivery channel 1 406A to process a successive message distributed to delivery channel 1 406A.

Based on not receiving an acknowledgement message in response to transmission of the first message processed by delivery channel 1 406A to the external payment network within a time out period, message delivery repository 432 may initiate channel manager 410 to shut down or restart delivery channel 1 406A. This may cause channel distributor 403 to reroute successive messages distributed to delivery channel 1 406A to another one of delivery channels 406B, 406C for processing. In some cases, channel manager 410 may reconfigure, shut down, or restart channel distributor 403 to force rerouting and avoid distributing additional messages to the failed delivery channel.

In some examples, message delivery repository 432 further ensures that each message can be traced back to its source and that its journey through the system is fully documented. Message delivery repository 432 may track the current status of each message (e.g., received, validated, processed, delivered) to monitor the health of the associated one of delivery channels 406 and/or EPG connector service 404 and detect any issues or delays. In the event of a failure of one of delivery channels 406, message delivery repository 432 may identify messages for which to replay or retry transmission to ensure that no messages are lost and that all messages are eventually delivered. In some examples, message delivery repository 432 may initiate channel manager 410 to shut down or restart a particular delivery channel identified as experiencing an error, exception, or failure.

Channel manager 410 may monitor and manage delivery channels 406 including tracking sequence numbers, acknowledgement cutoff or time out periods, associated queues of MQ 440 for transmission to the particular payment network, and whether the associated queues are active and available to receive messages. For example, during validate operation 422, delivery channel 1 406A may confirm with channel manager 410 that a previous message was acknowledged by the particular payment network within the cutoff or time out period, that the set of sequence numbers for delivery channel 1 406A was appropriately incremented, and/or that the associated queue of MQ 440 is active and available to receive the next message. As discussed above, if validation operation 422 fails when processing the first message, channel manager 410 may shut down or restart delivery channel 1 406A, causing channel distributor 403 to reroute the first message to another one of delivery channels 406B, 406C for processing.

Channel manager 410 may reset the set of sequence numbers unique to each of delivery channels 406 either periodically or in response to an event. As one example, channel manager 410 may automatically reset the set of sequence numbers for delivery channel 1 406A each day. As another example, channel manager 410 may automatically reset the set of sequence numbers for delivery channel 1 406A in response to a shutdown or restart of delivery channel 1 406A.

Channel manager 410 may also receive user input from administrators of EPG 400 via a user interface API to manually initiate reconfiguration, reset, shut down, or restart of one or more components of EPG connector service 404. For example, channel manager 410 may receive user input to initiate a reset of a set of sequence numbers unique to one of delivery channels 406. As another example, channel manager 410 may receive user input to initiate a replay or retry of transmission for a particular message from one of delivery channels 406. As a further example, channel manager 410 may receive user input to initiate a shutdown or restart of one of delivery channels 406.

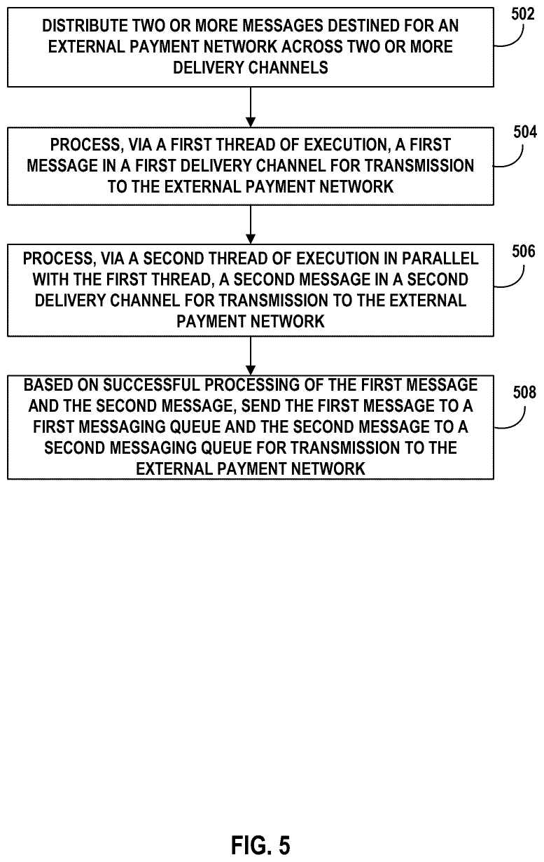

FIG. 5 is a flowchart illustrating an example operation of providing an enterprise payment gateway to distribute and process messages for transmission to an external payment network, in accordance with one or more techniques of this disclosure, in accordance with one or more techniques of this disclosure. The example operation of FIG. 5 is described with respect to EPG 350 of computing system 300 of FIG. 3. In other examples, the example operation may be performed by each of EPGs 110 of FIG. 1, EPG 200 of FIG. 2, or EPG 400 of FIG. 4.

EPG 350 distributes two or more messages of a plurality of messages destined for an external payment network across two or more delivery channels (502). EPG 350 may obtain the plurality of messages from one or more payment execution systems operating in one or more data centers. The messages may comprise payment message or non-payment messages. To distribute the two or more messages across the two or more delivery channels, channel distributor 322 may load balance the two or more messages of the plurality of messages across the two or more delivery channels, e.g., using a round robin algorithm.

EPG 350 processes, via a first thread of execution of a multi-threaded processor within processing circuitry 302, a first message of the two or more messages in a first delivery channel of the two or more delivery channels for transmission to the external payment network (504). To process the first message in the first delivery channel, sequence number generator 324 may generate a first sequence number for the first message from a set of sequence numbers unique to the first delivery channel in a manner that adheres to one or more rules of the external payment network. Sequence number generator 324 may then increment the set of sequence numbers unique to the first delivery channel for a successive message distributed to the first delivery channel.

EPG 350, via the first thread of the multi-threaded processor or via a single-threaded processor within processing circuitry 302, may then performs one or more single-threaded operations to determine whether the first message will be rejected by the external payment network. For example, EPG 350 may validate whether the first delivery channel and an associated first messaging queue are ready to process the first message. EPG 350 may also determine whether the first message in the first delivery channel is a duplicate message of another message in another one of the two or more delivery channels for the external payment network.

Based on an error or exception associated with the first message in the first delivery channel, EPG 350 may decrement the set of sequence numbers unique to the first delivery channel back to the first sequence number and reroute the first message to another one of the two or more delivery channels for transmission to the external payment network. In some examples, EPG 350 may reset the set of sequence numbers unique to the first delivery channel either periodically or in response to an event, e.g., shut down or restart of the first delivery channel in respond to an error or exception.

EPG 350 processes, via a second thread of execution of the multi-threaded processor in parallel with the first thread, a second message of the two or more messages in a second delivery channel of the two or more delivery channels for transmission to the external payment network (506). To process the second message in the second delivery channel, sequence number generator 324 may generate a second sequence number for the second message from a set of sequence numbers unique to the second delivery channel. EPG 350, via the second thread of the multi-threaded processor or via a single-threaded processor within processing circuitry 302, may then perform one or more single-threaded operations to determine whether the second message adheres to one or more rules of the external payment network, whether the second message comprises a valid format that will not be rejected by the external payment network, and/or whether the second message in the second channel is a duplicate message of another message in another one of the two or more delivery channels for the external payment network.

Based on an error or exception associated with the second message in the second delivery channel, EPG 350 may decrement the set of sequence numbers unique to the second delivery channel back to the second sequence number and reroute the first message to another one of the two or more delivery channels for transmission to the external payment network. In some examples, EPG 350 may reset the set of sequence numbers unique to the second delivery channel either periodically or in response to an event, e.g., shut down or restart of the second delivery channel in respond to an error or exception.

Based on successful processing of the first message and the second message, message publisher 326 sends the first message and the first sequence number to a first messaging queue and the second message and the second sequence number to a second messaging queue for transmission to the external payment network (508). Based on receipt of an acknowledgement message in response to transmission of the first message to the external payment network, EPG 350 may process a successive message distributed to the first delivery channel. Conversely, based on not receiving an acknowledgement message in response to transmission of the first message to the external payment network within a time out period, EPG 350 may shut down the first delivery channel and reroute successive messages distributed to the first delivery channel to another one of the two or more delivery channels for processing.

Similarly, based on receipt of an acknowledgement message in response to transmission of the second message to the external payment network, EPG 350 may process a successive message distributed to the second delivery channel. Based on not receiving an acknowledgement message in response to transmission of the second message to the external payment network within a time out period, EPG 350 may shut down the second delivery channel and reroute successive messages distributed to the second delivery channel to another one of the two or more delivery channels for processing.

In some examples, computing system 300, on which EPG 350 executes, comprises a distributed computing system that operates in an active mode within each data center of two or more data centers. In additional examples, the external payment network comprises a first external payment network and the two or more delivery channels comprise an isolated or discrete set of delivery channels for the first external payment network. EPG 350 may further distribute and parallel process two or more messages of a plurality of messages destined for a second external payment network across two or more delivery channels for the second external payment network. In this way, not only does each EPG parallel process and transmit messages for each external payment network, but multiple EPGs may operate in parallel across multiple data centers. Compared to conventional payment message management systems that are constrained to only send one message at a time, the EPG provides automated and reengineered workflows that enable payment network interaction based on payment network rules with high-availability, improved performance, and superior resiliency.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

For ease of illustration, only a limited number of devices are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each depict at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the illustrations and/or may include additional devices and/or components not shown in the illustrations.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated in the Figures herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In accordance with one or more aspects of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

What is claimed is:

1. A computing system comprising:
memory; and
processing circuitry in communication with the memory and configured to:
distribute two or more messages of a plurality of messages destined for an external payment network across two or more delivery channels;
process, via a first thread of execution, a first message of the two or more messages in a first delivery channel of the two or more delivery channels for transmission to the external payment network;
process, via a second thread of execution in parallel with the first thread, a second message of the two or more messages in a second delivery channel of the two or more delivery channels for transmission to the external payment network; and
based on successful processing of the first message and the second message, send the first message to a first messaging queue and the second message to a second messaging queue for transmission to the external payment network.

2. The computing system of claim 1, wherein to process the first message in the first delivery channel, the processing circuitry is configured to generate a first sequence number for the first message from a set of sequence numbers unique to the first delivery channel.

3. The computing system of claim 2, wherein to generate the first sequence number for the first message from the set of sequence numbers unique to the first delivery channel, the processing circuitry is configured to increment the set of sequence numbers for a successive message distributed to the first delivery channel.

4. The computing system of claim 3, wherein based on an error or exception associated with the first message in the first delivery channel, the processing circuitry is configured to:
decrement the set of sequence numbers back to the first sequence number; and
reroute the first message to another one of the two or more delivery channels for transmission to the external payment network.

5. The computing system of claim 2, wherein the processing circuitry is further configured to reset the set of sequence numbers unique to the first delivery channel one of periodically or in response to an event.

6. The computing system of claim 1, wherein to distribute the two or more messages across the two or more delivery channels, the processing circuitry is configured to load balance the two or more messages of the plurality of messages across the two or more delivery channels, wherein the two or more messages are load balanced using a round robin algorithm.

7. The computing system of claim 1, wherein to process the first message in the first delivery channel, the processing circuitry is further configured to perform one or more single-threaded operations to determine whether the first message will be rejected by the external payment network.

8. The computing system of claim 7, wherein to perform the one or more single-threaded operations, the processing circuitry is further configured to validate whether the first delivery channel and the first messaging queue are ready to process the first message.

9. The computing system of claim 7, wherein to perform the one or more single-threaded operations, the processing circuitry is further configured to determine whether the first message in the first delivery channel is a duplicate message of another message in another one of the two or more delivery channels for the external payment network.

10. The computing system of claim 1, wherein the processing circuitry is configured to, based on receipt of an acknowledgement message in response to transmission of the first message to the external payment network, process a successive message distributed to the first delivery channel.

11. The computing system of claim 1, wherein the processing circuitry is configured to, based on not receiving an acknowledgement message in response to transmission of the first message to the external payment network within a time out period, shut down the first delivery channel and reroute successive messages distributed to the first delivery channel to another one of the two or more delivery channels for processing.

12. The computing system of claim 1, wherein the processing circuitry is configured to obtain the plurality of messages from one or more payment execution systems operating in one or more data centers, wherein the messages comprise one or more of payment messages or non-payment messages.

13. The computing system of claim 1, wherein the computing system comprises a distributed computing system that operates in an active mode within each data center of two or more data centers.

14. The computing system of claim 1, wherein the external payment network comprises a first external payment network, wherein the two or more delivery channels comprise two or more delivery channels for the first external payment network, and wherein the computing system is further configured to distribute and parallel process two or more messages of a plurality of messages destined for a second external payment network across two or more delivery channels for the second external payment network.

15. A method comprising:
distributing, by a computing system, two or more messages of a plurality of messages destined for an external payment network across two or more delivery channels;
processing, via a first thread of execution of processing circuitry of the computing system, a first message of the two or more messages in a first delivery channel of the two or more delivery channels for transmission to the external payment network;
processing, via a second thread of execution of the processing circuitry of the computing system in parallel with the first thread, a second message of the two or more messages in a second delivery channel of the two or more delivery channels for transmission to the external payment network; and
based on successful processing of the first message and the second message, sending, by the computing system, the first message to a first messaging queue and the second message to a second messaging queue for transmission to the external payment network.

16. The method of claim 15, wherein processing the first message in the first delivery channel comprises generating a first sequence number for the first message from a set of sequence numbers unique to the first delivery channel.

17. The method of claim 16, wherein generating the first sequence number for the first message from the set of sequence numbers unique to the first delivery channel comprises:
incrementing the set of sequence numbers for a successive message distributed to the first delivery channel; and
based on an error or exception associated with the first message in the first delivery channel:
decrementing the set of sequence numbers back to the first sequence number, and
rerouting the first message to another one of the two or more delivery channels for transmission to the external payment network.

18. The method of claim 15, wherein processing the first message in the first delivery channel comprises performing one or more single-threaded operations to determine whether the first message will be rejected by the external payment network.

19. The method of claim 15, further comprising, based on not receiving an acknowledgement message in response to transmission of the first message to the external payment network within a time out period, shutting down the first delivery channel and rerouting subsequent messages to another one of the two or more delivery channels for processing.

20. Non-transitory computer-readable media storing instructions that, when executed, cause processing circuitry to:
distribute two or more messages of a plurality of messages destined for an external payment network across two or more delivery channels;
process, via a first thread of execution, a first message of the two or more messages in a first delivery channel of the two or more delivery channels for transmission to the external payment network;
process, via a second thread of execution in parallel with the first thread, a second message of the two or more messages in a second delivery channel of the two or more delivery channels for transmission to the external payment network; and
based on successful processing of the first message and the second message, send the first message to a first messaging queue and the second message to a second messaging queue for transmission to the external payment network.
